(19) United States
(12) Patent Application Publication
(10) Pub. No.: US 2017/0274737 A1
(43) Pub. Date: Sep. 28, 2017

(54) AIR POLLUTION REACTING SYSTEM IN A VEHICLE

(71) Applicant: Ford Global Technologies, LLC, Dearborn, MI (US)

(72) Inventor: Aurelien Pierre Christian Delaruelle, Glenroy (AU)

(21) Appl. No.: 15/437,339

(22) Filed: Feb. 20, 2017

(30) Foreign Application Priority Data
Mar. 28, 2016 (CN) 201610182047.3

(51) Int. Cl. B60H 3/00; B60H 3/06; B60H 1/00

(52) U.S. Cl. CPC B60H 3/0085; B60H 1/00764; B60H 1/008; B60H 1/00985; B60H 3/0608

(57) ABSTRACT

An air pollution reacting system in a vehicle comprises at least one air pollution measuring device installed in a vehicle and configured to measure an air pollution level of ambient air; and an air pollution reacting device configured to take at least one action in response to an air pollution level determined by the air pollution measuring device.

### RELATED APPLICATION

This application claims the benefit of Chinese Patent Application No.: CN 201610182047.3 filed on Mar. 28, 2016, the entire contents thereof being incorporated herein by reference.

### FIELD

The present application relates to an air pollution reacting system in a vehicle, more specifically relates to an air pollution reacting system that takes actions in response to an air pollution level.

### BACKGROUND

Air pollution becomes serious problems in some countries, especially in the countries with dense population and large manufacturing industries. Major air pollutants in the atmosphere include particulate matter, carbon monoxide (CO), nitrogen oxides (NOx), sulfur dioxide (SO₂), ozone and lead. People can know an air pollution level in a city or a big area of the city via public available sources, such as air quality forecast from TV and an internet. Such information on the air pollution level is often obtained from air monitoring stations in selected locations and may not reflect a real air pollution level in some areas. The drivers may be exposed to significantly different air pollution levels from the forecasted data when they drive from one place to another place.

The inventor has recognized that it may be desirable for the drivers to obtain the accurate information on the air pollution in their immediate surrounding atmosphere during their travel and to be alert of high air pollution level. Further, the inventor has recognized that it may be desirable that a vehicle may be operated to reduce air pollutants from the vehicle emission and to reduce the drivers' exposure to the air pollution in response to the real time air pollution level.

### SUMMARY

According to one aspect of the present disclosure, an air pollution reacting system in a vehicle is provided. The air pollution reacting system may comprise at least one air pollution measuring device installed in a vehicle and configured to measure an air pollution level of ambient air; and an air pollution reacting device configured to take at least one action in response to an air pollution level determined by the air pollution measuring device.

In one embodiment, the air pollution measuring device may include at least one of a particulate matter measuring device, a CO measuring device, a SO₂ measuring device, NOx measuring device, an ozone measuring device, and a lead measuring device.

In another embodiment, the action may include display of air pollution information on a cluster, a head up display on a center stack of the vehicle, or an in-vehicle device having a display screen.

In another embodiment, the action may be initiated when the air pollution level exceeds a predetermined value, and the action may include display of an alert indicating an unhealthy condition of the ambient air.

In another embodiment, the action may include display of a recommendation on a type of cabin air filter to be used in the vehicle.

In another embodiment, the action may include switching to a driving mode that generates less air pollutants when the air pollution level exceeds a predetermined level.

In another embodiment, the air pollution reacting system may further comprise a cabin air measuring device for determining one or more of conditions in a passenger compartment. The action may include switching to an air circulation mode with an increased air recirculation rate based on the air pollution level and the condition in the passenger compartment when the air pollution level exceeds a predetermined level.

According to another aspect of the present disclosure, an air pollution reacting system in a vehicle is provided. The air pollution reacting system may comprise at least one air pollution measuring device installed in a vehicle and configured to measure an air pollution level of ambient air; and an air pollution reacting device configured to enable a change of an operating mode of the vehicle and display of information related to air pollution when the pollution level determined by the air pollution measuring device exceeds a predetermined level.

In one embodiment, the operating mode may be at least one of a driving mode and an air circulation mode.

In another embodiment, display of information may include one or more of display of an alert on the air pollution level, a recommendation of a cabin air filter, and a current operating mode.

According to another aspect of the present disclosure, a method implemented in a vehicle is provided. The method may comprise receiving information on an ambient air pollution level; displaying air pollution information on an in-vehicle display device; and taking an action in response to an air pollution level.

In one embodiment, the vehicle may include an air pollution measuring device. Receiving the information on the air pollution level may include receiving the information from the air pollution measuring device.

In another embodiment, taking the action may include operating at a driving mode that generates less air pollutants when a measured air pollution level exceeds a predetermined level.

In another embodiment, the vehicle may be a hybrid vehicle and the driving mode that generates less air pollutants may include an electric-only mode or a driving mode with an increased torque supplied by an electric motor based on the air pollution level and a battery condition.

In another embodiment, the vehicle may be a gasoline or diesel powered vehicle and the driving mode that generates less air pollutants may include a driving mode wherein an internal combustion engine operating in a mode that consumes less fuel.

In another embodiment, the action may further comprise notifying a driver of a change in the driving mode.

In another embodiment, the method may further comprises determining one or more conditions in a passenger compartment. Taking the action may include operating an HVAC system in an air recirculation mode with an increased air recirculation rate based on the condition in a passenger compartment when the air pollution exceeds a predetermined level.

In another embodiment, the vehicle may be connected to a navigation system and an air quality forecast application or a server and receiving the information on the air pollution level may include receiving the information from the air quality forecast application or the server.

In another embodiment, the vehicle may include an air pollution measuring device, and receiving the information on the air pollution level may include receiving the information from the air pollution measuring device. The method may further comprise transmitting the air pollution level determined by air pollution measuring device to an air quality forecast application or a server.

In another embodiment, the vehicle may be connected to a navigation system and a quality forecast application or a server. The method may further comprise analyzing air pollution data obtained from the air quality forecast application and the air pollution measuring device and estimating air pollution on a destination and a route to the destination after a driver inputs the destination via an in-vehicle device; and alerting the driver of a high air pollution level when the air pollution level exceeds a predetermined level.

The system and the method of the present disclosure can provide real time air pollution information to a user because the in-vehicle devices re used to measure the air pollution level. Based on the air pollution information, actions can be taken by a vehicle to mitigate the effects of the ambient air pollution and/or reduce the contribution of the air pollution from the vehicle. For example, an operating mode of a vehicle can be changed so that an amount of air pollutants emitted from the vehicle is reduced. In another example, an air recirculation mode of the vehicle can be changed so that the passengers in the vehicle are exposed to less polluted air. Additionally, the passengers can be advised of taking appropriate actions to reduce the effect of the air pollution.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 depicts an embodiment of computing environment in which example embodiments of an air pollution reacting system of the present disclosure may be implemented.

FIG. 2 is a block diagram of an example vehicle system in which an example embodiment of an air pollution reacting system of the present disclosure may be implemented.

FIG. 3 shows an example method implemented by an air pollution reacting system of a vehicle according to an embodiment of the present disclosure.

FIG. 4 shows an example method implemented by an air pollution reacting system of a vehicle according to an embodiment of the present disclosure.

FIGS. 5A-5F show example displays on a display or a user interface of an in-vehicle device of an air pollution reacting system of a vehicle according to an embodiment of the present disclosure.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the present disclosure will now be described more fully with reference to the accompanying drawings, in which example embodiments are shown. Example embodiments of the present disclosure may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. Like reference numerals in the drawings denote like elements, and thus their description will be omitted.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”. “includes” and/or “including,” if used herein, specify the presence of stated features, integers, steps, operations, elements and/or components, but do not preclude the presence or addition of one or more other features, integers, steps, operations, elements, components and/or groups thereof.

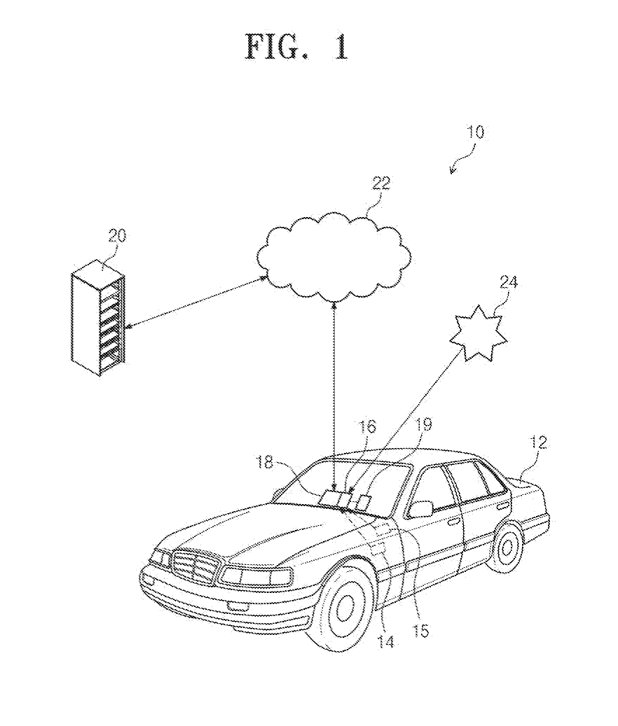

FIG. 1 depicts an embodiment of computing environment in which example embodiments of an air pollution system of the present disclosure may be implemented. The computing environment may be a telecommunications and/or data-processing system applicable to mobile devices such as vehicles and may be referred as a telematics system 10. The telematics system 10 may support an air pollution reacting system, navigation, vehicle control, communications, and/or entertainment of a vehicle 12, for example. The aspect of air pollution reacting system may provide features to measure an air pollution level surrounding the vehicle 12 and take at least one action in response to the measured air pollution level, for example. The telematics system 10 may include the vehicle 12 and an air pollution measuring device 14 installed in the vehicle 12. The air pollution measuring device 14 may include at least one of one of a particulate matter measuring device, a CO measuring device, a SO₂ measuring device, NOx measuring device, an ozone measuring device, and a lead measuring device to measure the concentrations of particulate matters, CO, SO₂, NOx ozone, or lead in the ambient air, respectively. The air pollution measuring device 14 may be installed in any suitable place of the vehicle 12. For example, the air pollution measuring device 14 may be disposed in a place where a representative air sample may be drawn without interference or minimized interference from air emission from a vehicle's tail pipe. In another example, a plurality of air measuring pollution devices may be disposed adjacent to each other in a housing. In still another example, at least two air pollution measuring devices may be disposed in one location and the rest of the air pollution measuring devices may be disposed in different locations separately depending on the features of a specific air pollution measuring device 14. It should be appreciated that the air pollution measuring device 14 is not limited to measure the concentrations of particulate matters. CO, SO₂, NOx, ozone or lead and it can be a device to measure any air pollutant. For example, the air pollution measuring device 14 may be a device to measure an air pollutant that is specifically present in an area and is emitted from a specific industry. The air pollutant may be an inorganic compound or may be an organic compound.

The telematics system 10 may further include a cabin air measuring device 15 for determining one of more conditions in a passenger compartment. The cabin air measuring device 15 may be an oxygen sensor, a CO sensor or a humidity sensor to measure an oxygen concentration, a CO concentration, or humidity. The results from the cabin measuring device 15 may indicate whether the condition in the passenger compartment is in a comfortable level for the passengers, or whether the ambient air needs to be drawn into the passenger compartment to provide sufficient oxygen. It should be appreciated that any suitable device may be used to determine the condition in the passenger compartment directly or indirectly.

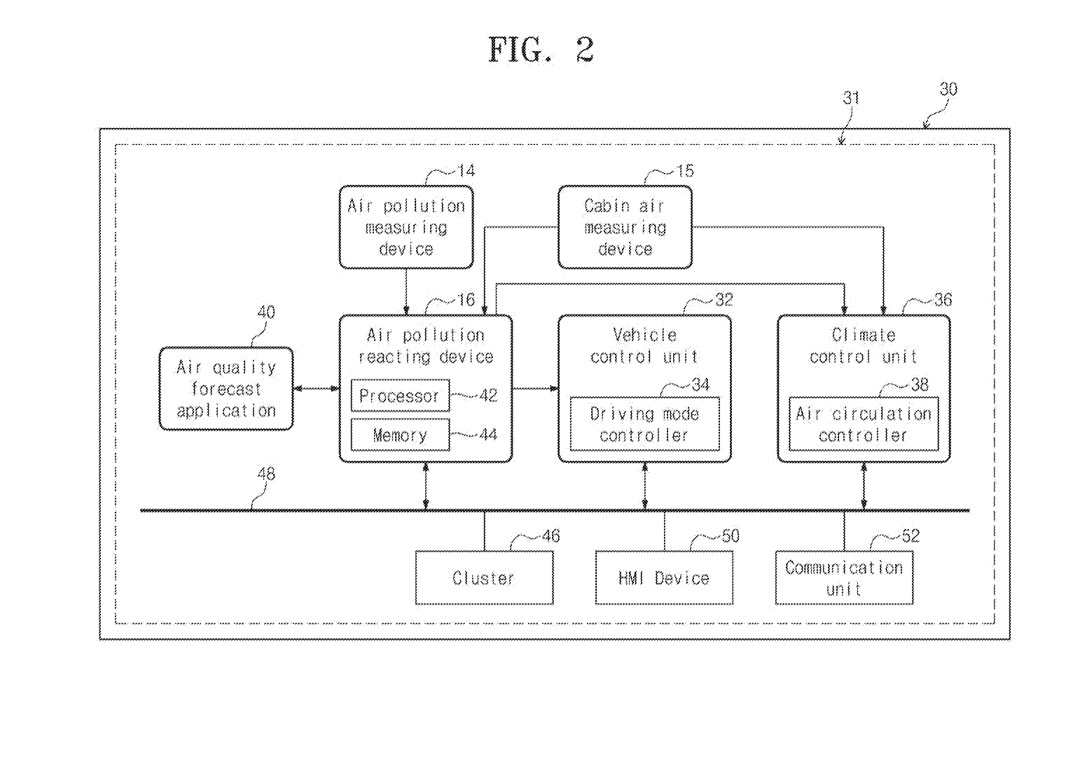

The telematics system 10 may include an air pollution reacting device 16 as described in more detail in FIG. 2. The air pollution reacting device 16 may receive air pollution information from the air pollution measuring device 14 and take actions in response to the measured air pollution level. In some embodiments, the air pollution reacting device may further receive information for the cabin air measuring device 15. In some embodiments, the air pollution reacting device 16 may be integrated in a vehicle's computer system. In some embodiments, the air pollution reacting device 16 may be incorporated into an in-vehicle device 18.

In some embodiments, the in-vehicle device 18 may be a human machine interaction (HMI) device. The HMI device may be a telecommunication and/or a data-processing device permanently or removably installed in the vehicle 12 to provide features such as navigation, entertainment, vehicle information and vehicle control among others. A user interface of the HMI may be used to input, output and display information.

The telematics system 10 may comprise a cluster or a head up display 19 to display various information.

The telematics system 10 may comprise a telematics server 20 that may provide various services to the vehicle 12 via a network. In some embodiments, the telematics server 20 may include air quality service or air quality forecast application. A user may subscribe the air quality service and the air quality service may provide air quality forecast to the air pollution reacting device 16. In some embodiments, the air pollution reacting device 16 may transmit the air pollution information measured by the air pollution measuring device 14 to the telematics server 20. The air pollution information from the vehicle 12 may provide accurate air pollution level at a route of the vehicle and improve the air quality forecast of the telematics server 20. In some embodiments, the air pollution reacting device 16 may receive air pollution information from the telematics server 20 and take actions accordingly. Thus, the air pollution measuring device 14 may not be needed.

The network 22 may include an internet. When the vehicle 12 is moving, the network 22 may employ one or more wireless communications technologies such as Wi-Fi, a cellular-telephone services such as 3G or 4G networks, direct satellite links, and/or terrestrial radio-frequency links. Any of these technologies, alone or in combination, may provide for data transfer between the vehicle 12, the telematics server 20, the air pollution reacting device 16 and other devices of the telematics system 10.

Positioning system 24 may be any device or system capable of determining the location of the vehicle 12. For example, the positioning system 24 may be a navigational system that transmits signals from satellite or terrestrial sources to receivers such as Global Positioning System (GPS). The GPS employs multiple satellites that broadcast signals containing time and position data. The GPS receiver can use the signals to determine a location. In another example, the positioning system 24 may be a terrestrial positioning system that may employ signals from transmitters that are one or more stationary antennas in known locations. Signals from cell-phone towers, for example, can be used to calculate the location of a receiver. In yet another example, the positioning system 24 may be a device that track location by dead reckoning. The dead-reckoning device may employ inertial navigation and/or sensors built into a vehicle. For example, a compass that measures direction combined with a drivetrain sensor that measures distance may provide position data such as a distance offset from a known starting point. It should be appreciated that the positioning system 24 may employ more than one technology.

FIG. 2 is a block diagram of an example vehicle system 30 in which an example embodiment of an air pollution reacting system 31 of the present disclosure may be implemented and illustrates the communications between the air pollution reacting device 16 and some electronic devices of the vehicle 12. The vehicle system 30 may comprise a vehicle control unit 32 that includes various controllers such as a driving mode controller 34. The driving mode controller 34 may control a power-train of the vehicle or control energy transformed into a form for propulsion purposes. In some embodiments, the vehicle 12 may be a gasoline or diesel powered vehicle, the driving mode controller 34 may control the power-train to operate in a mode to optimize the engine performance and fuel consumption. To obtain a desired performance, an engine control unit of the vehicle may control a series of actuators on an internal combustion engine to ensure optimal engine performance. The actuators may be adjusted by reading values from a multitude of sensors within the engine bay and interpreting the data using multidimensional performance maps. The driving mode controller 34 may also control the power-train to operate in a mode that provides more powerful driving force resulting in a quick acceleration or a mode that provides less powerful driving force resulting in a slower acceleration or a mode that optimize an operation of after-treatment system of the vehicle to reduce an amount of air pollutants emitted from the vehicle.

In some embodiments, the vehicle 12 may be a hybrid vehicle. The driving mode controller 34 may control a power-train to operate at an internal combustion-only mode or an electric-only mode. In some embodiments, the driving mode controller 34 may control the power-train to operate at an internal combustion mode and an electric mode wherein the internal combustion engine and the electric motor provide torque at different ratios.

The vehicle system 30 may comprise a climate control unit 36 that controls heating, ventilation and air conditioning (HVAC) of the vehicle 12. The climate control unit 36 may include an air circulation controller 38. In a HVAC system, a flow of inlet air may be drawn by a fan for conditioning and then delivered to a passenger compartment. The inlet air may be switched between an ambient air mode where only ambient air is drawn and an air recirculation mode where air recirculated from the passenger compartment is drawn. The passengers referred here include a driver. In some embodiments, in the air recirculation mode, a mixture of ambient air and recirculated air may be drawn into the HVAC system or the passenger compartment of the vehicle 12. When the vehicle is in the air recirculation mode for a prolonged period, the air in the passenger compartment may be humid and deficient of oxygen because of the presence of the passengers in the vehicle. Thus, the inlet air needs to be switched between the ambient air mode and the air recirculation mode. The switching between the ambient air mode and the air recirculation mode may be done by pressing a key on an operation control unit or may be automatically controlled. In the automatic controlled air circulation, the air circulation controller 38 may control the air recirculation rate at an allowable level to maintain a predetermined humidity and an oxygen concentration so that the passengers feel comfortable. The air recirculation rate may be determined based on a condition in the passenger compartment determined by a cabin air measuring device such as an oxygen sensor, a CO sensor or a humidity sensor, for example. In some embodiment, the information on the condition in the passenger compartment may be obtained from the sensors in the HVAC system. In some embodiments, the information on the condition in the passenger compartment may be determined from indirect parameters. For example, the information on a number of passengers may be used determined an amount of ambient air needed. Thus, the information on the condition of the passenger compartment may be obtained from an air bag system which may have information on a number of passengers in the vehicle.

The vehicle system 30 may further include other control units such as vehicle stability control unit, traction control unit and climate control unit (not shown in FIG. 2).

The vehicle system 30 may include the air pollution reacting device 16 that receives air pollution information and takes one or more actions in response to the air pollution information or the air pollution level. In some embodiments, the air pollution reacting device 16 may be connected to air quality forecast application 40 to receive the air pollution information in lieu of the information from the air pollution measuring device 14 or in addition to the information from the air pollution measuring device 14. The air quality forecast application 40 may be provided by the telematics server 20 as described in FIG. 1. In some embodiments, the air pollution reacting device 16 may be connected to both the air quality forecast application 40 and the air pollution measuring device 14. The air pollution reacting device 16 may take one or more actions based on information from the air pollution measuring device 14 and/or the air quality forecast application. Further, the air pollution reacting device 16 may transmit the air pollution information obtained from the air pollution measuring device 14 to the air quality forecast application.

The air pollution reacting device 16 may include a processor 42 that provides for computational resources. The processor 42 may serve to execute instructions for software that may be loaded into a memory unit 44. The instructions may include program code, computer-usable program code, or computer-readable program code. The memory unit 44 may be a storage device that is capable of storing information, such as, without limitation, data, program code in functional form, and/or other suitable information on either a temporary basis and/or a permanent basis. For example, the memory unit 44 may include a random access memory or any other suitable volatile or non-volatile storage device and a persistent storage. The persistent storage may be one or more devices such as a hard drive, a flash memory, a rewritable optical disk, a rewritable magnetic tape, or some combination of the above.

The air pollution reacting device 16 may be connected to the driving mode controller 34 to control a driving mode of the vehicle 12 in response to an air pollution level. The air pollution level may be determined by the air pollution measuring device 14. In some embodiments, the air pollution reacting device 16 may control the vehicle to be operated in to a driving mode that generates less air pollutants when the air pollution level exceeds a predetermined level. The driving mode that generates less air pollutants may be an economical driving mode that consumes less fuel. In some embodiments, in a gasoline or diesel powered vehicle, less fuel may be injected to the internal combustion engine, for example so that the vehicle operates in the economical mode. In another example of the gasoline or diesel powered vehicle, selected cylinders may be injected with fuel instead of all cylinders are injected with fuel in the economical mode. In some embodiments, in a hybrid vehicle, the economical driving mode may be an electric-only mode which runs based on a battery condition and the air pollution level. The battery condition may be a state of charge that allows the electric motor to run for a certain period before the battery needs to be charged by the engine or other sources. In another example of the economical driving mode, the ratio of electric motor to supply the torque may increase based on the battery condition while the power-train is operating at both an internal combustion mode and an electric mode.

In the economical driving mode, the vehicle may be less powerful and a driver may feel slower acceleration. However, less air pollutants are generated from the vehicle. The implementation of the economical driving mode in the vehicles collectively can reduce the air pollution from the vehicles on the roads.

In some embodiments, the air pollution reacting device 16 may be connected to the air circulation controller 38 to control an air circulation in the vehicle 12 in response to the air pollution level. In some embodiments, the air pollution reacting device 16 may control the air circulation controller 38 to switch to an air circulation mode with an increased air recirculation rate based on the air pollution level or the air pollution concentration and the condition in a passenger compartment. As less ambient air is introduced to the passenger compartment with the increases air recirculation, less amount of air pollutants is inhaled by the passengers. When the air pollution reaches a certain level, it may be beneficial to compromise between the unhealthy effect of the air pollution and comfort feel.

In some embodiments, the air pollution reacting device 16 may cause display of instructions on the air recirculation on a display device described below. For example, the air pollution reacting device 16 may instruct the driver to push the air recirculation button so that the vehicle is in the air recirculation mode, and then instruct the driver to push the ambient air button so that the vehicle is in the ambient air mode again after running the air recirculation mode for a certain period.

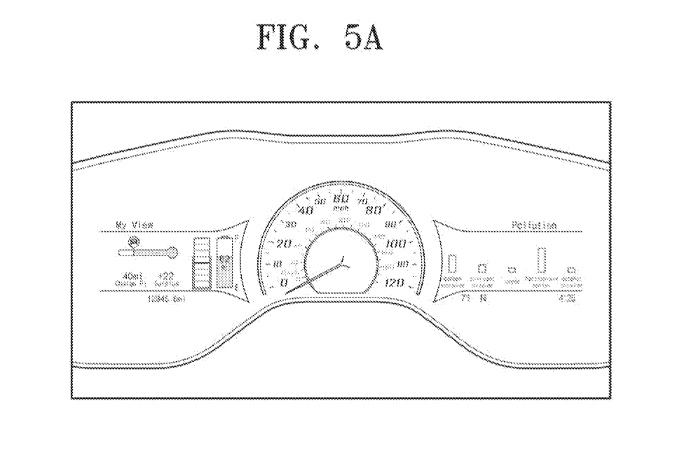

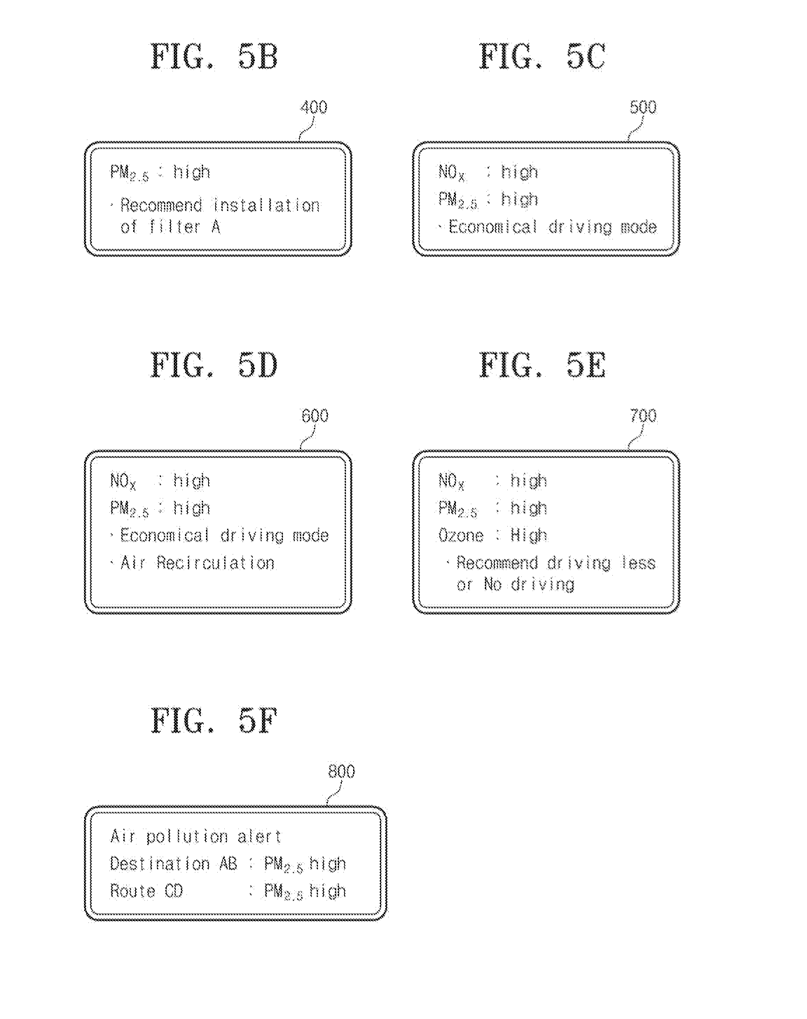

In some embodiments, the air pollution reacting device 16 may be communicated to a cluster or a head up display 46 of the vehicle via a bus 48 to display information related to air pollution as described in detail in FIGS. 5A-5F.

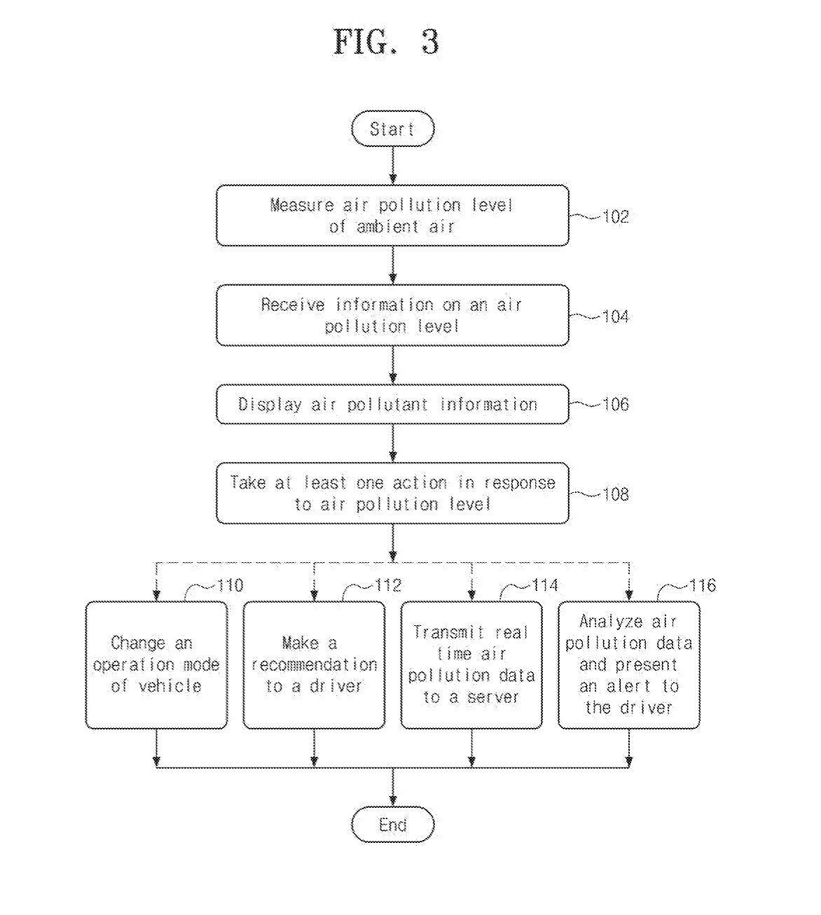

In some embodiments, the air pollution reacting device 16 may further be communicated with an in-vehicle device 50. The in-vehicle device 50 may be a device 18 described in FIG. 1. The in-vehicle device 50 may be a human machine interaction (HMI) device including a user interface having an input/output unit and a display. The air pollution information may be displayed on the display of the HMI device as described in detail in FIGS. 3-5. The user may enter an inquiry to request historical data on air pollution in some locations.

In some embodiments, the air pollution reacting device 16 may further be communicated with a communication unit 52 that provides communications with other data processing system or devices. For example, the communication unit 52 may be a network interface card and may communicate with the positioning system 24 as illustrated in FIG. 1 so that the location of the vehicle can be determined. As such, air pollution reacting device 16 may obtain a location and associate the location with air pollution data measured by the air pollution measuring device 14.

In some embodiments, the air pollution reacting system 31 may be a part of the vehicle system 30. The air pollution reacting device 16 may communicate with the various units or device in the vehicle system 30 to enable one or more actions in response to the air pollution level.

FIG. 3 is a flowchart showing an example method implemented by an air pollution reacting system of a vehicle according to an embodiment of the present disclosure. At 102, method 100 includes measuring air pollution level of the ambient air using at least one air pollution measuring device. As described in FIG. 1, the air pollution measuring device 14 may include at least one of a particulate matter measuring device, a CO measuring device, a SO₂ measuring device, NOx measuring device, an ozone measuring device and a lead measuring device to measure the concentrations of particulate matters, CO, SO₂, NOx, ozone or lead in the ambient air, respectively. It should be appreciated that the air pollution measuring device 14 is not limited to measure the concentrations of particulate matters, CO, SO₂, NOx, ozone or lead and it can be a device to measure any air pollutant. For example, the air pollution measuring device 14 may be a device to measure an air pollutant that is specifically present in an area and is emitted from a specific industry. The air pollutant may be an inorganic compound or may be an organic compound.

At 104, method 100 includes receiving air pollution information. In some embodiments, method 100 may include receiving the information on air pollution level from the air pollution measure device. In some embodiments, method 100 may include receiving the information on the air pollution level from the air quality forecast application or the air quality service server.

At 106, method 100 includes displaying air pollution information on a cluster, a head up display of or an in-vehicle device such as a HMI device in the vehicle. The air pollution information may be an air pollutant concentration or an air pollution level or may be information indicating the pollutant concentration at a high level or normal level. Method 100 may display the air pollution level continuously at a cluster, a head up display or an HMI device. Method 100 may display an alert to a driver when the air pollution concentration of a pollutant (e.g., particulate matter, CO, SO₂, NOx, lead or ozone) exceeds a predetermined level. The predetermined level may be a concentration of the pollutant that causes poor air quality or health concern. In other words, the predetermined level may be the level indicating an unhealthy condition of an ambient air.

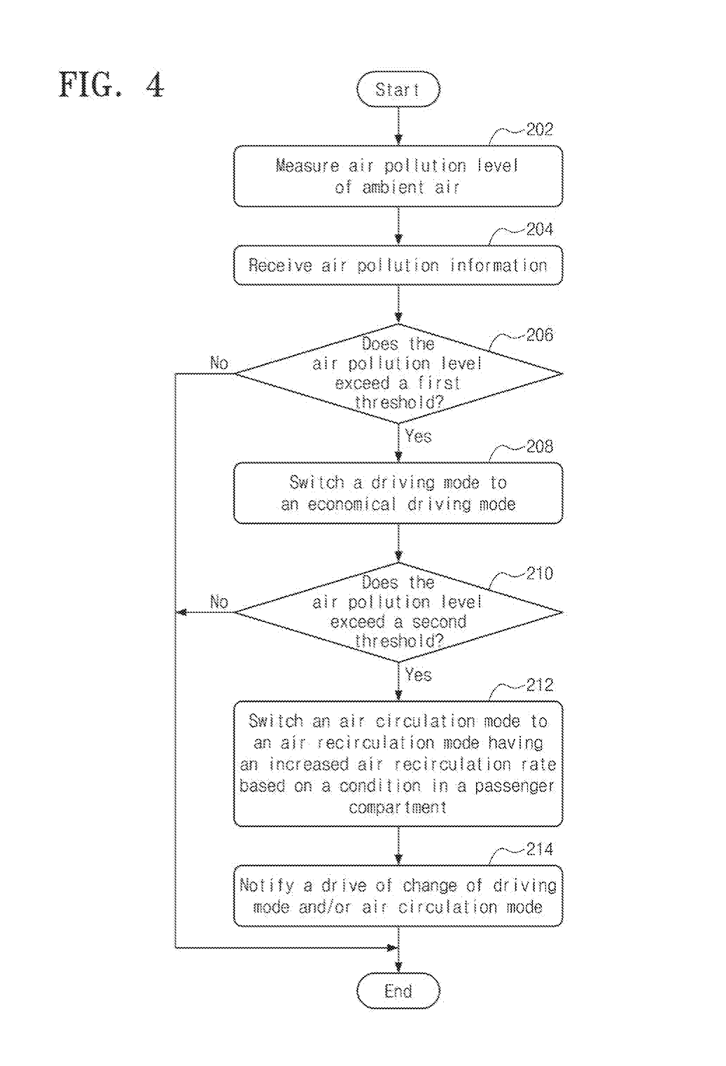

At 108, method 100 includes taking one or more actions in response to the air pollution level. In some embodiments, at 110, taking the action may include changing an operating mode of the vehicle. The operating mode may include a driving mode and/or an air recirculation mode as described in FIG. 2 and further described in FIG. 4.

At 112, in response to the air pollution level, method 100 includes making a recommendation to a driver. For example, method 100 may recommend installing a cabin air filter that effectively filters particulate matter (e.g., PM_{2.5}) if the particulate matter concentration exceeds a predetermined level. In another example, method 100 may recommend installing a cabin air filter that removes PM_{2.5} and CO if the particulate matter concentration and the CO concentration exceed predetermined PM_{2.5} and CO levels, respectively. Method 100 may further recommend a time period to change the cabin air filter or a time to change the cabin air filter based on the air pollution history. In some embodiments, the vehicle may be connected to a telematics server which may be a server of a vehicle manufacture or a server providing vehicle related services. Method 100 may recommend a cabin air filter that is made from the most current technologies and effectively filters certain air pollutants according to information from the telematics server.

At 114, in response to the air pollution level, method 100 includes transmitting real time air pollution data and location associated with the air pollution data to an air quality service server. The air pollution data provided by the vehicle may increase the sample size of the air quality service and thus improve the accuracy on estimation of the air pollutant level by the air quality service.

At 116, in response to the air pollution level, method 100 includes analyzing air pollution data and present an alert to a driver if the air pollution level is high. In some embodiments, method 100 may receive information on a destination and a route to the destination from an in-vehicle device such as a HMI device from a user's input after the vehicle is started. Then, method 100 may analyze the air pollution data measured by the air pollution measuring device 14 and/or data from the air quality server, and estimate the air pollution level at the destination and the route. If the estimated air pollution level is high, method may advise no driving or driving less.

FIG. 4 is a flow chart showing an example method implemented by an air pollution reacting system of a vehicle according to an embodiment of the present disclosure. At 202, method 200 includes measuring air pollution level of the ambient air using at least one air pollution measuring device. As described in FIG. 1, the air pollution measuring device 14 may include at least one of a particulate matter measuring device, a CO measuring device, a SO₂ measuring device. NOx measuring device, an ozone measuring device, and a lead measuring device to measure the concentrations of PM_{2.5}, CO, SO₂, NOx, ozone, or lead in the ambient air, respectively. It should be appreciated that the air pollution measuring device 14 is not limited to measure the concentrations of particulate matters, CO, SO₂, NOx, ozone or lead and it can be a device to measure any air pollutant. For example, the air pollution measuring device 14 may be a device to measure an air pollutant that is specifically present in an area and is emitted from a specific industry. The air pollutant may be an inorganic compound or may be an organic compound.

At 204, method 200 includes receiving air pollution information from the air pollution measuring device. In some embodiments, method 200 may include receiving the air pollution information from the air quality forecast application. In some embodiment, the method 200 may include receiving the air pollution information from the air quality service server.

At 206, method 200 includes determining whether the air pollution level exceeds a first threshold. If the answer at 206 is no, method 200 ends. If the answer at 206 is yes, method 200 continues to 208. At 208, method 200 includes switching a driving mode to an economical driving mode that produces less air pollutant. In some embodiments, the vehicle may be a hybrid vehicle. Method 200 includes operating at an electric-only mode or operating with an increased torque supplied by an electric motor based on the air pollution level and a battery condition. In some embodiments, the vehicle may be a gasoline or diesel powered vehicle. Method 200 includes operating an internal combustion engine at a mode that consumes less fuel.

At 210, method 200 includes determining whether the air pollution level exceeds a second threshold. The second threshold may be equal to or greater than the first threshold. If the answer at 210 is no, method 200 ends. If the answer at 210 is yes, method 200 continues to 212. At 212, method 200 includes switching an air circulation mode to an air recirculation mode having an increased air recirculation rate based on a condition in the passenger compartment.

Next, at 214, method 200 includes notifying the driver of the change of the driving mode and the air circulation mode. During the change of the operating mode change, the driver may feel some difference. For example, in the economical driving mode, the driver may experience different vehicle performance, such as less powerful and slower acceleration. With increased air recirculation rate, the driver may feel less comfortable air environment. Method 200 notifies the driver the change and thus alert the driver the presence or possible presence of the different feels.

FIG. 5A-5F shows an example displays of an air pollution reacting system of a vehicle according to an embodiment of the present disclosure. FIG. 5A shows that air pollutant levels are displayed on a cluster 300 of the vehicle. The pollution levels of CO, NOx, ozone, particulate matters and SO₂ are displayed in a bar diagram. It should be appreciated that the air pollution information may be displayed in any suitable formats. For example, the display may show a threshold of each pollutant above which air quality is poor along with the air pollution levels or show information whether the current air quality is good or poor for each air pollutant.

FIG. 5B-5F show displays of air pollution reacting system in a display device of a vehicle such as an HMI device. It should be appreciated that the display may be present at on a cluster, a head up display or any other suitable displays in a vehicle. FIG. 5B shows a display 400 that alerts high PM_{2.5} concentration. The display 400 further display a recommendation for installation of a filter A. The filter A may be a type of cabin air filter that is effective to filter PM_{2.5}. The display may further indicate the specific filters available in the market.

FIG. 5C shows a display 500 that indicates PM_{2.5} concentration and NOx concentration are high. The display 500 further indicates that the vehicle is in an economical driving mode. A driver may have different driving experience such as feel slower acceleration and less powerful in the economical driving. The display of the economical driving mode acknowledges the driver the possible presence of different driving feels.

FIG. 5D shows a display 600 that alerts PM_{2.5} concentration and NOx concentration are high. The display 600 further indicates that the vehicle is in an economical driving mode and air recirculation mode. As described above in FIG. 2, it may be beneficial to operate the HVAC system at the air recirculation mode at longer duration or more frequently when the air pollution concentrations reach a certain level. A driver may feel discomfort at such air recirculation mode. The display of the air recirculation mode acknowledges the driver the current air circulation mode. The display 600 may further display an economical driving mode when the vehicle is operating in the economical driving mode at the same time.

FIG. 5E shows a display 700 that alerts PM_{2.5} NOx and ozone concentrations are high. The display 700 may be presented to the driver after the driver starts the vehicle. The vehicle may be connected to the telematics server as described in FIG. 1 which provide information on the air quality or information needed to estimate the air quality. The air pollution reacting system may estimate the air pollution level in the surrounding area of the vehicle based on information stored in the air pollution reacting system and/or information from an air quality service. When PM_{2.5}, NOx and ozone concentrations reach a certain level, the air pollution reacting system may instruct the driver to drive less or no driving before the driver leaving his or her residence.

FIG. 5F shows a display 800 that alerts air pollution at some locations. The display 800 may be presented to the driver after the driver starts the vehicle. The vehicle may be connected to the telematics server as described in FIG. 1 that provides information on the air quality or information needed to estimate the air quality. The vehicle may further be connected to a navigation system. When the driver enters his/her destination AB, the navigation system may provide a route CD to the destination. The air pollution reacting system may estimate the air pollution level at the destination AB and the route CD based on information stored in the air pollution reacting system and/or information from an air quality service. If the estimated air pollutant concentration exceeds a predetermined level, the display may alert the driver the high pollutant concentration in the destination AB or the route CD. In FIG. 5F, the display shows that the PM_{2.5} is high in the destination AB and the route CD.

The air pollution reacting system and the air pollution reacting method of the present disclosure have various advantages. For example, the system provides accurate and real time information on the air pollution level because the air pollution information is determined by the air pollution measuring device installed in a vehicle. Thus, a user of the air pollution reaction system is informed of the air pollution level in his/her immediate surrounding atmosphere. Further, the air pollution reacting system can automatically switch the vehicle to a driving mode that generates less air pollution when the air pollution exceeds a predetermined level. In this way, the air pollution caused by the vehicle can be reduced. Furthermore, the air pollution reacting system can automatically switch the vehicle to an air recirculation mode or instruct the driver to put the air recirculation mode at an allowable condition so that the driver and passengers are exposed less to the polluted air when the air pollution exceeds a predetermined level. Moreover, the air pollution reacting system advises the driver to install a specific air cabin filter designed to remove one or more air pollutants when the air pollution caused by these pollutants are high. The installation of the specific air cabin filter can improve the air quality in the cabin even though the ambient air is severely polluted.

Note that the example control and estimation routines included herein can be used with various engine and/or vehicle system configurations. The specific routines described herein may represent one or more of any number of processing strategies such as event-driven, interrupt-driven, multi-tasking, multi-threading, and the like. As such, various acts, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated acts or functions may be repeatedly performed depending on the particular strategy being used. Further, the described acts may graphically represent code to be programmed into computer readable storage medium in the engine control system.

It will be appreciated that the configurations and routines disclosed herein are exemplary in nature, and that these specific embodiments are not to be considered in a limiting sense, because numerous variations are possible.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application.

The invention claimed is:

1. An air pollution reacting system in a vehicle, comprising:
at least one air pollution measuring device installed in a vehicle and configured to measure an air pollution level of ambient air; and
an air pollution reacting device configured to take at least one action in response to an air pollution level determined by the air pollution measuring device.

2. The air pollution reacting system of claim 1, wherein the air pollution measuring device includes at least one of a particulate matter measuring device, a CO measuring device, a SO₂ measuring device, a NOx measuring device, an ozone measuring device and a lead measuring device.

3. The air pollution reacting system of claim 1, wherein the at least one action includes display of air pollution information on a cluster, a head up display on a center stack of the vehicle, or an in-vehicle device having a display screen.

4. The vehicle operation system of claim 3, wherein the action is initiated when the air pollution level exceeds a predetermined value, and the action includes display of an alert indicating an unhealthy condition of the ambient air.

5. The air pollution reacting system of claim 1, wherein the action includes display of a recommendation on a type of cabin air filter to be used in the vehicle.

6. The air pollution reacting system of claim 1, wherein the action includes switching to a driving mode that generates less air pollutants when the air pollution level exceeds a predetermined level.

7. The air pollution reacting system of claim 1, further comprises a cabin air measuring device for determining one or more of conditions in a passenger compartment, wherein the action includes switching to an air circulation mode with an increased air recirculation rate based on the air pollution level and the condition in the passenger compartment when the air pollution level exceeds a predetermined level.

8. An air pollution reacting system in a vehicle, comprising:
at least one air pollution measuring device installed in a vehicle and configured to measure an air pollution level of ambient air; and
an air pollution reacting device configured to enable a change of an operating mode of the vehicle and display of information related to air pollution when the pollution level determined by the air pollution measuring device exceeds a predetermined level.

9. The air pollution reacting system of claim 8, wherein the operating mode is at least one of a driving mode and an air circulation mode.

10. The air pollution reacting system of claim 8, wherein display of information includes one or more of display of an alert on the air pollution level, a recommendation of a cabin air filter, and a current operating mode.

11. A method implemented in a vehicle, comprising:
receiving information on an ambient air pollution level;
displaying air pollution information on an in-vehicle display device; and
taking at least one action in response to an air pollution level.

12. The method of claim 11, wherein the vehicle includes an air pollution measuring device, wherein receiving the information on the air pollution level includes receiving the information from the air pollution measuring device.

13. The method of claim 12, wherein taking the action includes operating at a driving mode that generate less air pollutants when a measured air pollution level exceeds a predetermined level.

14. The method of claim 13, wherein the vehicle is a hybrid vehicle and the driving mode that generates less air pollutants includes an electric-only mode or a driving mode with an increased torque supplied by an electric motor based on the measured air pollution level and a battery condition.

15. The method of claim 13, wherein the vehicle is a gasoline or diesel powered vehicle and the driving mode that generates less air pollutants includes a driving mode wherein an internal combustion engine operating in a mode that consumes less fuel.

16. The method of claim 13, wherein the action further comprises notifying a driver of a change in the driving mode.

17. The method of claim 11, further comprising determining one or more conditions in a passenger compartment, wherein taking the action includes operating an HVAC system in an air recirculation mode with an increased air recirculation rate based on the condition in a passenger compartment when a measured air pollution level exceeds a predetermined level.

18. The method of claim 11, wherein the vehicle is connected to a navigation system and an air quality forecast application or a server and wherein receiving the information on the air pollution level includes receiving the information from the air quality forecast application or the server.

19. The method of claim 11, wherein the vehicle includes an air pollution measuring device, wherein receiving the information on the air pollution level includes receiving the information from the air pollution measuring device, and wherein the method further comprising transmitting the air pollution level determined by air pollution measuring device to an air quality forecast application or a server.

20. The method of claim 12, wherein the vehicle is connected to a navigation system and a quality forecast application or a server, and the method further comprising:
analyzing air pollution data obtained from the air quality forecast application and the air pollution measuring device and estimating air pollution on a destination and a route to the destination after a driver inputs the destination via an in-vehicle device; and
alerting the driver of a high air pollution level when the air pollution level exceeds a predetermined level
